(19) United States
(12) Patent Application Publication
(10) Pub. No.: US 2018/0031596 A1
(43) Pub. Date: Feb. 1, 2018

(54) Speed Analyzer

(71) Applicant: Frank Steven Bell, New Wilmington, PA (US)

(72) Inventor: Frank Steven Bell, New Wilmington, PA (US)

(21) Appl. No.: 15/220,504

(22) Filed: Jul. 27, 2016

(51) Int. Cl. G01P 11/00; G01S 17/08

(52) U.S. Cl. CPC G01P 11/00; G01S 17/08

(57) ABSTRACT

An article and method are described that measure the average speed of an object. A timer measures the time an object takes to travel from a start to a finish. A goniometer measures the angle between the start, the article, and the finish. A wave generator determines the distances from the article to the start and finish. Using a geometric identity, the distance traveled by the object from the start to the finish can be determined and, using the time, the average speed can be calculated. The article and method are especially suitable for quickly measuring the average speed of objects moving below about 10 m/s and without defining a predetermined path. An electronic processor can be used to automate the method.

This application claims priority to U.S. provisional application 62/197,729 filed 28 Jul. 2015.

### FIELD OF THE INVENTION

The invention relates to an article for the measurement of the speed of an object without the need for a predetermined path, and is particularly useful for measuring walking or running speed in the health care industry.

### BACKGROUND OF THE INVENTION

Waves have been used to measure the speed of objects. Waves include, electromagnetic radiation and sound. Electromagnetic radiation includes, but is not limited to, laser and infrared light.

In order to measure the speed of an object, a path of known distance can be identified using first and second wave generators. In a specific example, first and second lasers are placed at the beginning and end of the path, respectively. An object breaking the beam of the first laser triggers a timer that is stopped when the object breaks the beam of the second laser. Dividing the distance by the time defines the speed. This method has the disadvantage of requiring a prior set-up.

Another method of speed detection uses the Doppler Effect, which is common to all waves. For example, a laser produces a laser light that reflects from an object. The wavelength of the reflected laser light will differ from the incident light depending on the speed and direction of the object. This provides a near instantaneous measurement of speed. The accuracy of the measurement, however, is subject to various factors such as the angle between the laser and the direction of the object's motion, the position of the capturing receiver, and noise in the electromagnetic spectrum. Errors can exceed 0.5 m/s. While such errors are relatively small at high speeds, it can invalidate any measurement at low speeds such as walking.

A need persists for an article that accurately determines speed when an object is moving at slow speeds, that is below about 10 m/s, without the need to define a pre-determined path.

### SUMMARY OF THE INVENTION

A speed measuring device comprises a timer, a goniometer, and at least one wave generator mounted on the goniometer. Preferably, the device includes an electronic processor for calculations. The device measures the speed of an object without the need for a predetermined path as in traditional methods. Compared to traditional methods, the device permits easy, rapid collection of data and the ability to accommodate various testing conditions.

The timer measures the time for the object to travel from a start to a finish. The goniometer includes any article capable of measuring an angle and can include, for example, a protractor. The goniometer measures an angle between the start and the finish. The wave generator produces a signal that can reflect from an object first at the start and then at the finish. The wave generator includes an emitter that produces a beam and a sensor that can detect the beam after the beam reflects from the object, so that the distances of the object from the device at the start and finish can be determined. Using the distances and the angle, the distance from the start and finish can be calculated. The average speed of the object between the start and the finish can thereby be determined.

The speed of a person or object (collectively “object”) can be determined as the object moves from the start to the finish. A triangle is formed by (a) distance from the start to the object, D₁, (b) the distance from the finish to the object, D₂, and (c) distance the object travels between the start and the finish, D₃. In embodiments, a processor uses D₁, D₂, and the angle measured by the goniometer to determine D₃. The average speed of the object is D₃ divided the time the object takes to travel from start to finish.

In embodiments, the device comprises a wave generator capable of producing a wave of light or sound, and a detector capable of receiving a reflected wave from the object. The wave comprises, for example, a beam of laser light, infrared light, or sound. The wave generator rotates from pointing at a start to a finish. Optionally, the device includes a visible indicator to show the start and/or finish. The indicator can include a beam of laser light or a mechanical pointer. The wave generator measures the distance from the device to an object at the start and from the device to the same object when at the finish. The goniometer measures the angle between the start and finish positions. A speed of the object can then be calculated. Advantageously, the angle between the start and the finish can be adjusted to accommodate various situations.

In an alternative embodiment, the device includes a plurality of wave generators. A first wave generator points towards the start and a second wave generator points to the finish. The first and second generator define an angle, which preferably can be adjusted as needed but can be fixed for simplicity. The generators can determine the distance from the device to the object at the start and the object at the finish. Knowing the time, the object took to travel from the start to the finish, one can calculate the average speed of the object.

The speed measuring device can be used to measure the speed of objects, and is especially useful for objects those moving at speeds less than about 10 m/s, where Doppler measurements can include significant error. In an example, the device can be used by physical therapists to measure the walking speed of a person, which is typically less than 3 m/s. Of course, the device can also be used for faster-moving objects. The device requires no pre-determined path or gates through which the object must pass. The device comprising a timer and processor enables a quick determination of an object's speed with little effort by the technician.

### BRIEF DESCRIPTION OF THE DRAWING

FIG. 1 shows the device of the present invention.

FIG. 2 shows a schematic of the trigonometric method of calculating distance using the device of FIG. 1.

FIG. 3 shows a perspective view of an embodiment of the device.

FIG. 4 is a side view of the device of FIG. 3.

FIG. 5 is an exploded perspective view of the device in FIG. 3.

FIG. 6 is detail exploded perspective view of the wave generator assembly of FIG. 3.

### DETAILED DESCRIPTION OF THE INVENTION

The device comprises a timer, a goniometer, and at least one wave generator capable of measuring the distance to an object. The timer measures the time for the object to travel from a start to a finish. The goniometer measures the angle between the start and the finish. The wave generator is mounted so that a beam from the wave generator correlates to the direction of the goniometer. Conveniently, the beam is parallel to the direction. An object in the beam's path can reflect the wave back to a sensor on the wave generator. The wave generator can then rotate so that the wave generator points to the finish, and the wave generator can detect the object when it passes the finish.

In embodiments, a processor can receive the time, the goniometer angle, and signals from the wave generator. The processor can calculate the distances of the object from the wave generator at the start and finish. The processor can use the angle between the start and finish, and the distance to the object at the start and finish to calculate the average speed of the object as it moved between the start and finish. In embodiments, a plurality of wave generators can be used. For example, a first wave generator can point to the start and a second wave generator can point to the finish.

The wave generator can include any device that emits a wave capable of reflecting from an object and detecting the reflected wave. A wave reflecting from an object at the start can trigger a timer in the device and the difference between an emitted wave and a detected wave can be used to determine the distance to the object. In embodiments, the wave generator comprises an electromagnetic wave generator and a sensor for detecting a wave that is reflected from the object. The electromagnetic wave can include laser light, such as for example, infrared light. Alternatively, the wave generator includes a sound generator and sensor. Preferably, the sound generator produces ultrasound and its emission and detection is similar to sonar equipment.

The goniometer can be any type that permits interfacing with the wave generator. The goniometer can be a fixed angle or a variable angle. A variable angle goniometer permits greater flexibility in use by allowing a user to vary the distance traveled by the object. The goniometer can also be digital, thereby interfacing more easily with the processor. Of course, the goniometer can be both variable angle and digital.

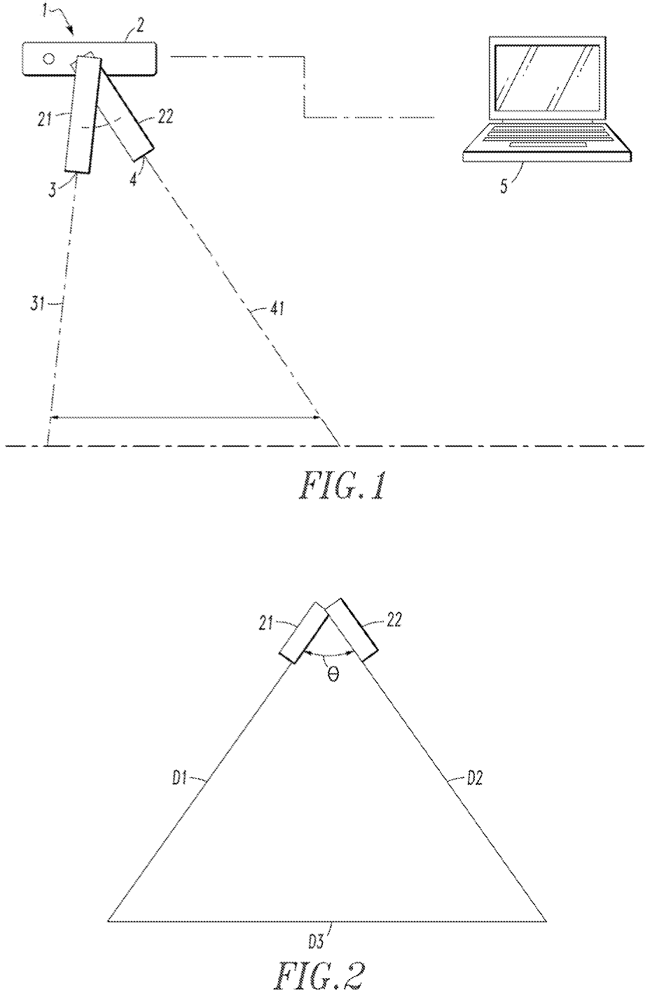

FIG. 1 shows an embodiment of the device 1 comprising a goniometer 2 including a first arm 21 and a second arm 22. A laser 3, 4 is mounted on each arm 21, 22 so that a first beam 31 from the first laser 3 projects parallel to the first arm 21 and a second beam 41 from the second laser 4 projects parallel to the second arm 22. An object (not shown) passing through the first beam 31 reflects the first beam 31 back to the first laser 3, thereby producing a first signal. A processor 5 can use the first signal to determine the distance of the object from the first laser 3 and trigger a timer. The processor can be integral or extrinsic to the device. The object can then move so that it intersects the second beam 41. The second beam 41 then reflects from the object back to the second laser 4, thereby producing a second signal. The processor 5 can use the second signal to determine the distance of the object from the second laser 4 and stop the timer, thereby defining a time, t.

Knowing the angle between the lasers, the distance from the object to the first laser, the distance from the object to the second laser, and the time interval, the processor can calculate the average speed of the object between the first and second beam.

Calculating the speed involves identifying a third side of a triangle when two sides and the angle between the sides are known. FIG. 2 shows a diagram of the mathematics needed to calculate the average speed. The arms of the goniometer form an angle, θ. The lasers, which are mounted parallel to the arms, therefore also form an angle θ. It is understood the lasers could be mounted otherwise relative to the arms. The mathematics is essentially the same but for an angle correction, so “parallel” is understood to mean lasers mounted at a known angle to the arms of the goniometer. The processor uses the first signal to calculate the distance between the first laser and the object, D₁, and uses the second signal to calculate the distance between the second laser and the object, D₂. The length of the remaining side, D₃, can be determined using trigonometry or, more simply, is given by the law of cosines:

C²=A²+B²−2AB cos θ, where A=D₁, B=D₂, and C=D₃.

The processor also determines the time, t, that the object takes to travel from the first beam to the second beam. The average speed is defined as the distance an object travels divided by the time in which it takes to travel that distance. Accordingly, the average speed of the object will by D₃/t.

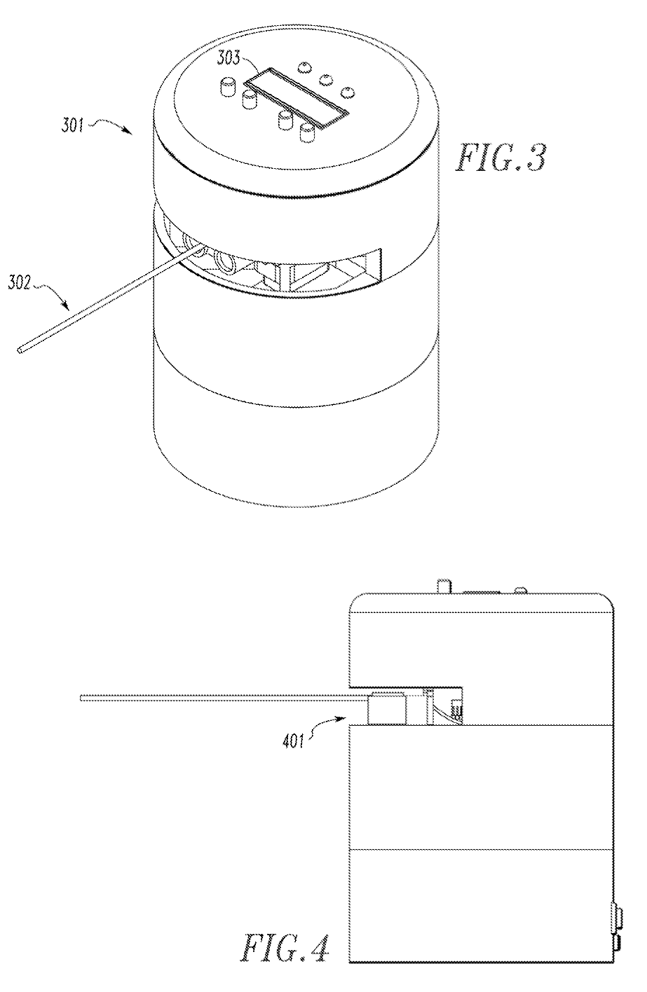

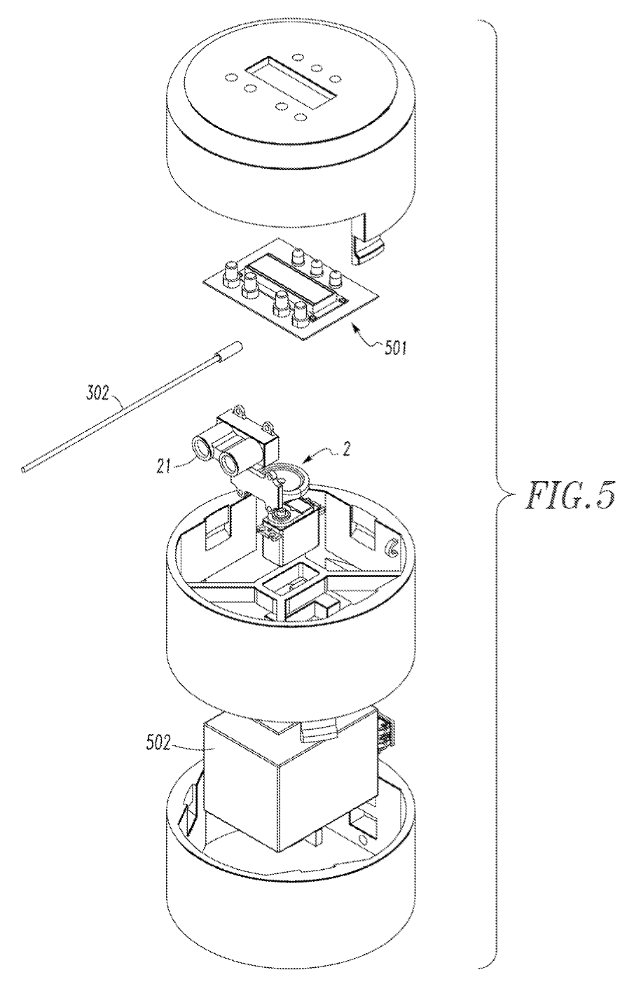

FIG. 3-5 shows an embodiment of the device in an integrated unit 301. In this embodiment, a single wave generator 21 rotates from a start to a finish along an angle. A window 401 permits the wave to be sent from the wave generator and the reflected wave to be received by the sensor. The window 401 can limit the operable angle permitted by the device. Alternatively, the window could be replaced by a material substantially transparent to the wave. The wave generator 21 can be mounted to a goniometer 2. An indicator 302 identifies the start. The indicator 302 may or may not travel with the wave generator 21. Signals from the wave generator 21 and the goniometer 2 are sent to a processor 501. The processor 501 can display the average speed on a display 303. Optionally, the device 301 can include a battery 502 for portability.

The goniometer can produce an electronic signal that can be sent to a processor. In one such embodiment, the goniometer comprises an angular magnetic rotary encoder. The angular magnetic rotary encoder includes a magnet coupled through a rotor with an electronic sensor. As the rotor turns, the magnet passes a plurality of alternate north-south poles oriented around a circumference of the rotor. The sensor detects variations in the electromagnetic field as the magnet passes the poles. In embodiments of the present invention, the magnet rotates synchronously with the wave generator, whereby an electronic signal from the angular magnetic rotary encoder corresponds to an angle.

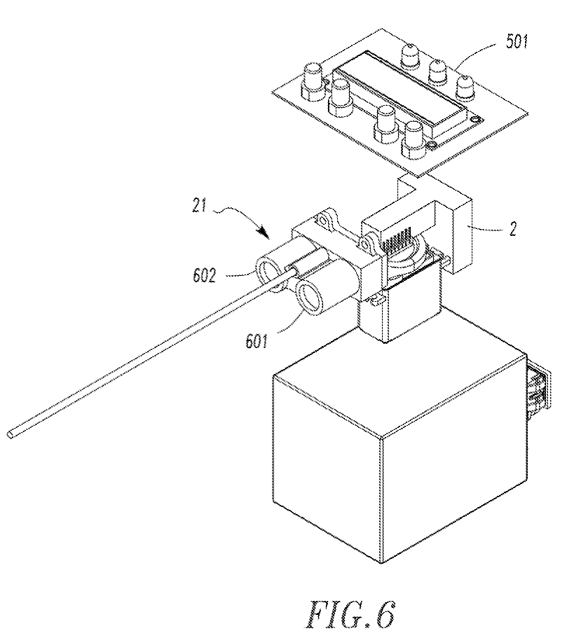

FIG. 6 shows the wave generator 21 mounted to the goniometer 2. The wave generator includes an emitter 601 and a sensor 602. The emitter 601 generates a wave. The sensor 602 receives a reflection of the wave. The indicator 302 is mounted parallel to the wave generator 21. Signals from the wave generator 21 and the goniometer are transferred to the processor 501.

In embodiments, the signals can be sent electronically to the processor from the goniometer and wave generators. The signal can even be sent wirelessly, for example, via Bluetooth or WiFi. Alternatively, the signals can be manually input into the processor.

In other embodiments, the processor is a dedicated unit integral to the device and has a read out displaying speed, and optionally the distances and time. Of course, the processor could by a general purpose computer.

In embodiments, a plurality of measurements can be made so that the speed of the object can be calculated as the object moves from the start to the finish. For example, as the object moves from the start to the finish, the object will pass through a point, x. The device can determine a distant, Dₓ, from the device to the object at point x. Using the angle formed by the start, the device and point x, the distance traveled by the object from the start to point x can be calculated and the object's average speed from the start to point x can be calculated. Obviously, this can be repeated as many times as desired so that variations in speed from the start to the finish can be measured.

The device is not limited to two-dimensional motion. Using the wave generator and the angle, the device could be adapted to triangulate the position of the object in a three-dimensional space.

### EXAMPLE

The walking speed of five individuals was measured using both a standard clinical technique, that is, a timed course, and the device of the present invention. A researcher set up a standard timed course using a starting line, finish line, a tape measure, and a timer. Timed courses of 4, 5, 6, 7 and 8 meters in length were prepared. The researcher collected the times and calculated the average speed of each individual on the various length courses. The researcher also measured the average speed of the five individuals using the device. No set-up was required and speed calculations were performed automatically by the processor. The two techniques measured the same speeds to within 0.1 m/s or less for all distances. This is within experimental error. While the speed measurements were the same, the device was able to capture average speeds in about one-half the time as the standard technique. Actual values were 50 seconds and 1:45 minutes for the device and standard clinical technique, respectively This represents a significant time savings in a clinical environment.

Numerous modifications and variations of the present invention are possible. It is, therefore, to be understood that within the scope of the following claims, the invention may be practiced otherwise than as specifically described.

1. A device for measuring an average speed of an object comprising:
a. a timer for measuring the time, t, for the object to travel from a start to a finish;
b. at least one wave generator capable of measuring (i) the distance, D₁, from the device to the start and (ii) the distance D₂, from the device to the finish;
c. a goniometer that measures an angle, θ, between the start, the wave generator, and the finish;
whereby the average speed is D₃/t, where D₃²=D₁²+D₂²−2 D₁D₂ cos θ.

2. The device of claim 1, wherein the wave generator comprises a wave emitter producing a beam and a sensor for detecting the beam after the beam is reflected from the object, whereby a distance from the object to the wave generator can be determined.

3. The device of claim 1, wherein the wave generator rotates from pointing at the start to pointing at the finish.

4. The device of claim 1, wherein the wave generator is mounted to an arm of the goniometer and the arm rotates through the angle, θ, from the start to the finish.

5. The device of claim 1, wherein the timer, goniometer and wave generator generate electronic signals that are transferred to an electronic processor, and the electronic processor calculates the average speed of the object from the start to the finish.

6. The device of claim 1, wherein the beam is selected from a group consisting of electromagnetic wave or sound wave.

7. The device of claim 6, wherein the electromagnetic wave is selected from a group consisting of laser light, infrared light, and combinations thereof.

8. The device of claim 1, further comprising at least one visible indicator to show a location selected from a group consisting of the start, the finish, and combinations thereof.

9. The device of claim 8, wherein the visible indicator is selected from a group consisting of a laser light, a mechanical pointer, and combinations thereof.

10. The device of claim 1, comprising a plurality of wave generators including a first wave generator directed to the start and a second wave generator directed to the finish.

11. The device of claim 1, wherein the angle, θ, is variable.

12. A method for measuring the average speed of an object moving from a start to a finish using a device, the method comprising:
a. Measuring the time, t, the object takes to travel from the start to the finish;
b. Determining the distance, D₁, from the device to the object at the start;
c. Determining the distance, D₂, from the device to the object at the finish;
d. Measuring the angle, θ, formed by the start, the device and the finish; and
e. Calculating the distance traveled by the object from the start to the finish, D₂, using the formula D₃²=D₁²+D₂²−2D₁ D₂ cos θ; and
f. Finding the average speed of the object by dividing D₃ by t.

13. The method of claim 12, wherein the device comprises:
a. a timer for measuring the time, t, for the object to travel from a start to a finish;
b. at least one wave generator comprising a wave emitter producing a beam and a sensor for detecting the beam after the beam is reflected from the object, thereby determining distances, D₁ and D₂;
c. a goniometer that measures the angle, θ.

14. A device for measuring an average speed of an object comprising:
a. a timer for measuring the time, t, for the object to travel from a start to a finish;
b. a goniometer including a first arm and a second arm that define an angle, θ;
c. a first wave generator mounted on the first arm and pointing to the start, the first wave generator comprising a first wave emitter producing a first beam and a first sensor for detecting the first beam after the first beam is reflected from the object, whereby the start distance, Di, from the wave generator to the object can be determined;
d. a second wave generator mounted on the second arm, the second wave generator comprising a second wave emitter producing a second beam and a second sensor for detecting the second beam after the second beam is reflected from the object, whereby the finish distance, D₂, from the wave generator to the object can be determined;
whereby the average speed is D₃/t, where D₃²=D₁²+D₂²−2 D₁ D₂ cos θ, and D₁ is the distance from the start to the object, D₂ is the distance from the finish to the object, and θ is the angle.

15. The device of claim 14, wherein the first and second beams are parallel to the first and second arms, respectively.

16. The device of claim 14, wherein the timer, goniometer and wave generators generate electronic signals that are transferred to an electronic processor, and the electronic processor calculates the average speed of the object from the start to the finish.

17. The device of claim 14, wherein the beam is selected from a group consisting of electromagnetic wave or sound wave.

18. The device of claim 17, wherein the electromagnetic wave is selected from a group consisting of laser light, infrared light, and combinations thereof.

19. The device of claim 18, further comprising at least one visible indicator to show a location selected from a group consisting of the start, the finish, and combinations thereof.

20. The device of claim 19, wherein the visible indicator is selected from a group consisting of a laser light, a mechanical pointer, and combinations thereof.
